(19) United States
(12) Patent Application Publication
(10) Pub. No.: US 2025/0263237 A1
(43) Pub. Date: Aug. 21, 2025

(54) HYDROGEN STORAGE IN UNDERGROUND FORMATIONS USING FOAM

(71) Applicant: Saudi Arabian Oil Company, Dhahran (SA)

(72) Inventors: Guoqing Jian, Houston, TX (US); Ayrat Gizzatov, Cambridge, MA (US); Ashok Santra, Houston, TX (US); Bo Ren, Houston, TX (US); Roland Martinez, Houston, TX (US); Kenneth Dejuan Johnson, Houston, TX (US)

(21) Appl. No.: 18/581,904

(22) Filed: Feb. 20, 2024

(51) Int. Cl. B65G 5/00; C01B 3/02

(52) U.S. Cl. CPC B65G 5/005; C01B 3/02

(57) ABSTRACT

The disclosure relates to systems and methods for hydrogen storage in underground formations using foam. The methods include injecting a foam including hydrogen and a surfactant into the underground formation or injecting hydrogen and a surfactant into the underground formation and forming a foam in the underground formation.

### FIELD

The disclosure relates to systems and methods for hydrogen storage in underground formations using foam. The methods include injecting a foam including hydrogen and a surfactant into the underground formation or injecting hydrogen and a surfactant into the underground formation and forming a foam in the underground formation.

### BACKGROUND

Hydrogen can be stored in underground formations such as caverns, aquifers, and/or depleted oil/gas reservoirs. The hydrogen can subsequently be produced.

### SUMMARY

The disclosure relates to systems and methods for hydrogen storage in underground formations using foam. The methods include injecting a foam including hydrogen and a surfactant into the underground formation or injecting hydrogen and a surfactant into the underground formation and forming a foam in the underground formation.

Without wishing to be bound by theory, the systems and methods regulate (e.g., control) the mobility of hydrogen stored in a porous media (e.g., porous rocks in an underground formation). The systems and methods can provide improved hydrogen storage capacity relative to certain other systems and methods for underground hydrogen storage by reducing hydrogen mobility. Thus, early breakthrough and fingering through a high permeable streak can be reduced (e.g., prevented).

The hydrogen stored underground can be produced with better and more uniform sweep efficiency during the injection process relative to certain other systems and methods for underground hydrogen storage. The sweep volume may also be increased relative to certain other systems and methods for underground hydrogen storage.

The systems and methods of the disclosure can be relatively simple and/or inexpensive to implement.

In a first aspect, the disclosure provides a method including injecting a foam including hydrogen and a surfactant into an underground formation.

In some embodiments, the method further includes, prior to injecting the foam, mixing the hydrogen and the surfactant to form the foam.

In some embodiments, the method further includes, before mixing the hydrogen and the surfactant, disposing the surfactant in a liquid, wherein a concentration of the surfactant used to form the foam is from 0.1 wt. % to 2 wt. % in the liquid.

In some embodiments, a volume ratio of hydrogen to surfactant in the foam is from 1:1 to 20:1.

In some embodiments, a volume fraction of hydrogen is from 50 vol. % to 95 vol. % of the foam.

In some embodiments, the underground formation includes a member selected from the group consisting of an aquifer, a cavern, and a depleted oil or gas reservoir.

In some embodiments, the method further includes, after injecting the foam into the underground formation, producing hydrogen from the underground formation.

In some embodiments, the surfactant includes a member selected from the group consisting of an anionic surfactant, a cationic surfactant, a nonionic surfactant and a zwitterionic surfactant.

In some embodiments, the surfactant includes a surfactant selected from the group consisting of:
an anionic surfactant selected from the group consisting of sodium lauryl sulfate (SLS), sodium laureth sulfate (SLES), sodium cocoyl isethionate (SCI), sodium lauryl sulfoacetate (SLSA), alpha olefin sulfonates (AOS), sodium dodecylbenzene sulfonate (SDBS), sodium alkyl ether sulfate (AES), sodium lauryl ether sulfate (SLES), sodium lauroyl sarcosinate (SLS), and sodium lauroyl glutamate;
a cationic surfactant selected from the group consisting of cetyltrimethylammonium bromide (CTAB), cetrimonium chloride, stearalkonium chloride, behentrimonium chloride, protonated primary, secondary and tertiary amines and fatty amine derivatives and ethoxylated amines;
a nonionic surfactant selected from the group consisting of alkyl ethoxylated, alkylphenol ethoxylated, alkyl ethylene oxide (EO) and propylene oxide (PO) block copolymers; and
a zwitterionic surfactant selected from the group consisting of cocamidopropyl betaine, cetyl betaine, lauryl betaine, oleamidopropyl betaine, capryl/capramidopropyl betaine, decyl glucoside betaine, stearyl betaine, behenyl betaine, and cetrimonium betaine.

In a second aspect, the disclosure provides a method including forming, within an underground formation, a foam including hydrogen and a surfactant.

In some embodiments, the method further includes, prior to forming the foam, injecting the hydrogen and the surfactant into the underground formation.

In some embodiments, the hydrogen and the surfactant are coinjected. In some embodiments, the hydrogen is injected at a first time and the surfactant is injected at a second time different from the first time.

In some embodiments, the method further includes, before injecting the surfactant, disposing the surfactant in a liquid, wherein a concentration of the surfactant used to form the foam is from 0.1 wt. % to 2 wt. % in the liquid.

In some embodiments, a volume ratio of hydrogen to surfactant solution in the foam is from 1:1 to 20:1.

In some embodiments, a volume fraction of hydrogen is from 50 vol. % to 95 vol. % of total fluid injected.

In some embodiments, the underground formation includes a member selected from the group consisting of an aquifer, a cavern, and a depleted oil or gas reservoir.

In some embodiments, the method further includes, after forming the foam in the underground formation, producing hydrogen from the underground formation.

In some embodiments, the surfactant includes a member selected from the group consisting of an anionic surfactant, a cationic surfactant, a nonionic surfactant and a zwitterionic surfactant.

In some embodiments, the surfactant includes a surfactant selected from the group consisting of:
an anionic surfactant selected from the group consisting of sodium lauryl sulfate (SLS), sodium laureth sulfate (SLES), sodium cocoyl isethionate (SCI), sodium lauryl sulfoacetate (SLSA), alpha olefin sulfonates (AOS), sodium dodecylbenzene sulfonate (SDBS), sodium alkyl ether sulfate (AES), sodium lauryl ether sulfate (SLES), sodium lauroyl sarcosinate (SLS), and sodium lauroyl glutamate;
a cationic surfactant selected from the group consisting of cetyltrimethylammonium bromide (CTAB), cetrimonium chloride, stearalkonium chloride, behentrimonium chloride, protonated primary, secondary and tertiary amines and fatty amine derivatives and ethoxylated amines;
a nonionic surfactant selected from the group consisting of alkyl ethoxylated, alkylphenol ethoxylated, alkyl ethylene oxide (EO) and propylene oxide (PO) block copolymers; and
a zwitterionic surfactant selected from the group consisting of cocamidopropyl betaine, cetyl betaine, lauryl betaine, oleamidopropyl betaine, capryl/capramidopropyl betaine, decyl glucoside betaine, stearyl betaine, behenyl betaine, and cetrimonium betaine.

In a third aspect, the disclosure provides a system including an underground formation including a member selected from the group consisting of an aquifer, a cavern, and a depleted oil or gas reservoir; and a foam disposed in the underground formation. The foam includes hydrogen and a surfactant.

### BRIEF DESCRIPTION OF THE FIGURES

FIG. 1 depicts a flowchart for a method.

FIG. 2 depicts a flowchart for a method.

FIG. 3 depicts a schematic for a liquid film barrier.

FIG. 4 depicts a structure of an alpha-olefin sulfonate.

FIG. 5 depicts a structure of an ethoxylated amine.

FIG. 6 depicts structure of an alkyl ethoxylated copolymer.

FIG. 7 depicts a structure of cetyl betaine.

FIG. 8 depicts a schematic of a depleted reservoir, a cavern, and an aquifer.

FIG. 9A shows an image of solution containing a surfactant and hydrogen before mixing.

FIG. 9B shows an image of a cell containing a surfactant and hydrogen before mixing.

FIG. 10A shows an image of a cell containing a foam formed by mixing hydrogen and surfactant.

FIG. 10B shows an image of a cell containing a foam formed by mixing hydrogen and surfactant with a pressure gradient applied.

### DETAILED DESCRIPTION

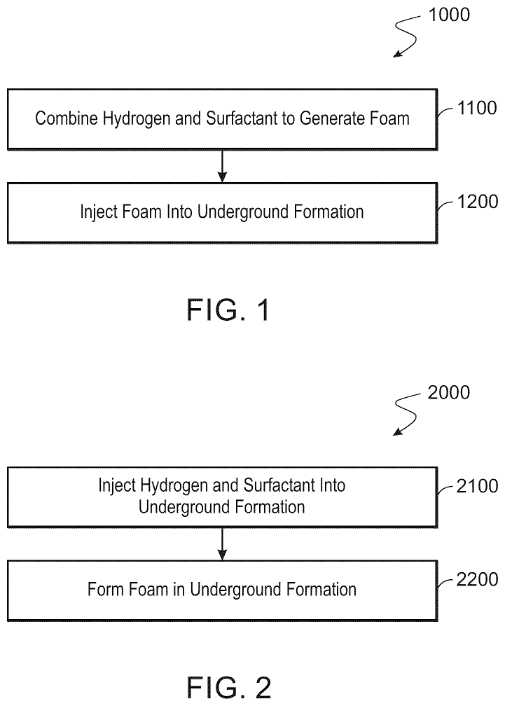

FIG. 1 depicts a flowchart for a method 1000 of forming a foam including hydrogen and a surfactant outside of an underground formation, and subsequently injecting the foam into the underground formation.

In step 1100, hydrogen and the surfactant are combined to generate a foam. Hydrogen is included in the foam generated in the step 1100 by thoroughly mixing the hydrogen and surfactant (e.g., using an inline mixer). In general, the foam can be generated using any appropriate method or foam generator such as using an inline frit foam generator or foam blender. In some embodiments, the foam blender includes mixing in a closed tank with relatively high-speed blending. In some embodiments, use of an inline frit is preferred.

In step 1200, the foam is injected into the underground formation.

FIG. 2 depicts a flowchart for a method 2000 of forming a foam including hydrogen and a surfactant within an underground formation.

In step 2100 hydrogen and the surfactant are injected into the underground formation. Hydrogen and the surfactant can be injected using co-injection or cyclic injection. In some embodiments, cyclic injection includes injecting the hydrogen at a first time and injecting the foam at a second time different from the first time. In some embodiments, the second time is after the first time. In some embodiments, the second time is before the first time.

In step 2200, the foam is created in the underground formation. Without wishing to be bound by theory, it is believed that the foam is generated spontaneously as the gas and liquid flow together through the porous rock media, such as through a snap-off mechanism.

Without wishing to be bound by theory, it is believed that cyclic injection is generally preferrable as coinjection has less injectivity. For cyclic injection, the cycles may be determined based on the total pore volume (PV) of the reservoir and can range from 0-0.5 PV for one cycle. Relatively small values of the cycle such as 0.01 PV can allow for relatively fast cycle switching.

In the methods 1000 and 2000, prior to their use in forming the foam, the hydrogen can be stored in and injected from a hydrogen tank and pipelines and the surfactant and can be stored in and injected from a surfactant tank. In the methods 1000 and 2000 the foam or hydrogen and surfactant can be injected with water or brine.

Without wishing to be bound by theory, it is believed that the presence of the surfactant stabilizes the foam and allows the foam to regulate (e.g., reduce) the mobility of hydrogen during storage in porous media (e.g., an underground formation), thereby reducing the potential for hydrogen migration through fractures and high-permeability layers. This can improve the storage capacity of hydrogen within the porous media.

Without wishing to be bound by theory, it is believed that hydrogen will be stored within the porous medium (e.g., rock) in locations that were initially occupied by water (when stored in an aquifer) or by gas, water, and/or oil (when stored in a depleted gas or oil reservoir) (see discussion below). It is believed that the hydrogen can be entrapped within the porous medium by capillary forces until it is released during production (see discussion below).

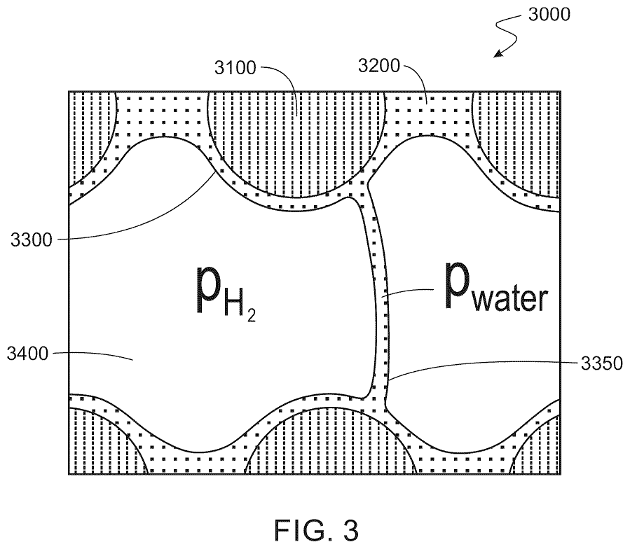

Without wishing to be bound by theory, it is believed that foam formation within porous media initiates the creation of thin liquid lamellae. As these lamellae traverse the porous medium, they induce an increase in the pressure gradient. Consequently, the mobility of hydrogen is reduced as it must overcome the capillary pressure generated by these liquid lamellas within the porous medium. FIG. 3 shows a schematic 3000 for a liquid film barrier. Pores 3200 are formed between the rock grains 3100. A water film or surfactant solution 3300 attaches to the surfaces of the rock grains 3100. A liquid film barrier 3350 traps hydrogen gas in the region 3400.

Without wishing to be bound by theory, it is believed that according to the Young-Laplace equation, there is a pressure difference (gas pressure vs liquid pressure) across the liquid film barrier 3350. Since there are thousands of such films in the porous media, they add up to generate a pressure gradient. The capillary pressure is the pressure difference of nonwetting phase (the region 3400 with H₂ gas) and wetting phase (surfactant solution), which generates a relatively strong pressure gradient.

Without wishing to be bound by theory, it is believed that hydrogen gas within the foam can become separated with the lamella structures. However, it is believed that the hydrogen can still diffuse across the films. Without wishing to be bound by theory, it is believed that the foam is initially used as carrier to deliver H₂ to the target zone in the pores of rock, then the H₂ can occupy the space which is originally occupied by other phases such as water or oil. The H₂ will then be trapped by capillary pressure in the pores (capillary trapping H₂ storage). It is also believed that part of the hydrogen is adsorbed on the surface of rock, but most of it is trapped by foam lamella in the pores.

The Young-Laplace Equation for thin liquid films and the equation for the thin film barrier shown in FIG. 3 is:

$$Δ p = {p}_{{H}_{2}} - {P}_{water} = \frac{4 γ}{r}$$

where γ denotes the surface tension between hydrogen and water (or surfactant solution), and r represents the principal radii of the lamellae. Consequently, hydrogen contends with an additional pressure gradient of 4γ/r to facilitate its movement. Given the presence of numerous such foam films within the porous media, this cumulative extra pressure gradient imposed on the hydrogen significantly reduces its mobility. Without wishing to be bound by theory, it is believed that the surface tension of H₂ and water is a function of pressure and temperature. Typical values are 51 mN/m at 798 psi and 20° C. and 46 mN/n at 1450 psi and 45° C. It is also believed that the radii of the lamella are relatively close to the magnitude of pore throat of rock, which is at the level of microns.

Without wishing to be bound by theory, it is believed that relatively high temperatures can accelerate the decay of the foam by draining liquids in the films. In some embodiments, the temperature at which the foam is produced and/or disposed in the underground formation is at least 20 (e.g., at least 30, at least 40, at least 50, at least 60, at least 70, at least 80, at least 90, at least 100, at least 110)° C. and/or at most 120 (e.g., at most 110, at most 100, at most 90, at most 80, at most 70, at most 60, at most 50, at most 40, at most 30)° C.

Without wishing to be bound by theory, it is believed that the pressure affects the density of hydrogen and typical reservoir pressures can maintain hydrogen in the gas phase. In certain embodiments, the reservoir has a pressure of at least 500 (e.g., at least 600, at least 700, at least 800, at least 900, at least 1000, at least 1500, at least 2000, at least 2500, at least 3000, at least 3500, at least 4000, at least 4500) psi and/or at most 5000 (e.g., at most 4500, at most 4000, at most 3500, at most 3000, at most 2500, at most 2000, at most 1500, at most 1000, at most 900, at most 800, at most 700, at most 600) psi.

Typically, the surfactant is included in a liquid, such as water or brine, and the surfactant-containing liquid is used when making the foam. Without wishing to be bound by theory, it is believed that the concentration of the surfactant can affect the formation of foam; however, if the concentration exceeds the Critical Micelle Concentration (CMC) of the surfactant, the concentration will not significantly affect the formation of foam. It is also believed that in general, with more surfactant and form foamed, there is greater potential to store hydrogen underground. In some embodiments, the concentration of the surfactant in the liquid to form the foam in the method 1000 or injected into the underground formation in the method 2000 is at least 0.1 (e.g., at least 0.2, at least 0.3, at least 0.4, at least 0.5, at least 0.6, at least 0.7, at least 0.8, at least 0.9, at least 1, at least 1.1, at least 1.2, at least 1.3, at least 1.4, at least 1.5, at least 1.6, at least 1.7, at least 1.8, at least 1.9) wt. % and/or at most 2 (e.g., at most 1.9, at most 1.8, at most 1.7, at most 1.6, at most 1.5, at most 1.4, at most 1.3, at most 1.2, at most 1.1, at most 1, at most 0.9, at most 0.8, and most 0.7, at most 0.6, at most 0.5, at most 0.4, at most 0.3, at most 0.2) wt. %.

Without wishing to be bound by theory, it is believed that the ratio of hydrogen to surfactant can affect the formation of foam. Without wishing to be bound by theory, it is believed that when the ratio of hydrogen to surfactant is relatively low (corresponding to less gas and more surfactant) the foam is wet, and when the ratio of hydrogen to surfactant is relatively high (corresponding to more gas and less surfactant) the foam is dry. A reasonable value of gas and liquid ratio by volumes is used to generate foam for a specific reservoir at given temperature and pressure conditions. In some embodiments, the volume ratio of hydrogen (gas) to surfactant solution (liquid) used to form foam in the method 1000 or injected into the underground formation in the method 2000 is at least 1:1 (e.g., at least 2:1, at least 3:1, at least 4:1, at least 5:1, at least 6:1, at least 7:1, at least 8:1, at least 9:1, at least 10:1, at least 11:1, at least 12:1, at least 13:1, at least 14:1, at least 15:1, at least 16:1, at least 17:1, at least 18:1, at least 19:1) and/or at most 20:1 (e.g., at most 19:1, at most 18:1, at most 17:1, at most 16:1, at most 15:1, at most 14:1, at most 13:1, at most 12:1, at most 11:1, at most 10:1, at most 9:1, at most 8:1, at most 7:1, at most 6:1, at most 5:1, at most 4:1, at most 3:1, at most 2:1).

In some embodiments, the concentration of hydrogen used to form foam in the method 1000 or injected into the underground formation in the method 2000 is at least 50 (e.g., at least 55, at least 60, at least 65, at least 70, at least 75, at least 80, at least 85, at least 90) vol. % and/or at most 95 (e.g., at most 90, at most 85, at most 80, at most 75, at most 70, at most 65, at most 60, at most 55) vol. % of the foam or total fluid injected.

In some embodiments, the pressure of the hydrogen used to form foam in the method 1000 or injected into the underground formation in the method 2000 is at least 14.7 (e.g., at least 15, at least 20, at least 25, at least 30, at least 35, at least 40, at least 45, at least 50, at least 55, at least 60, at least 65, at least 70, at least 75, at least 80, at least 85, at least 90, at least 95, at least 100, at least 150, at least 200, at least 250, at least 250, at least 300, at least 350, at least 400, at least 450, at least 500, at least 550, at least 600, at least 650, at least 700, at least 750, at least 800, at least 850, at least 900, at least 950, at least 1000, at least 1100, at least 1200, at least 1300, at least 1400, at least 1500, at least 1600, at least 1700, at least 1800, at least 1900, at least 2000, at least 2500, at least 3000, at least 3500, at least 4000, at least 4500, at least 5000, at least 5500, at least 6000, at least 6500, at least 7000, at least 7500, at least 8000, at least 8500, at least 9000, at least 9500, at least 10000, at least 11000, at least 12000, at least 13000, at least 14000) psi and/or at most 15000 (e.g., at most 14000, at most 13000, at most 12000, at most 11000, at most 10000, at most 9500, at most 9000, at most 8500, at most 8000, at most 7500, at most 7000, at most 6500, at most 6000, at most 5500, at most 5000, at most 4500, at most 4000, at most 3500, at most 3000, at most 2500, at most 2000, at most 1500, at most 1000, at most 950, at most 900, at most 850, at most 800, at most 750, at most 700, at most 650, at most 600, at most 550, at most 500, at most 450, at most 400, at most 350, at most 300, at most 250, at most 200, at most 150, at most 100, at most 95, at most 90, at most 85, at most 80, at most 75, at most 70, at most 65, at most 60, at most 55, at most 50, at most 45, at most 40, at most 35, at most 30, at most 25, at most 20, at most 15) psi.

In general, the surfactant can include an anionic surfactant, a cationic surfactant, a non-ionic surfactant and/or a zwitterionic surfactant. In some embodiments, a combination of different surfactants can be used. For example, in some embodiments, alpha olefin sulfonates (AOS) and lauryl betaine (LB) can be used together. Without wishing to be bound by theory, it is believed that because LB includes both positive charge and negative charge in each molecule, it can form ion-pairs with AOS which can enhance the surfactant stabilized hydrogen foam film. Without wishing to be bound by theory, it is believed that some surfactant blend formulations may behave better than only one of the surfactant components for generating relatively strong foams (e.g., LB and AOS). Without wishing to be bound by theory, it is believed that the stronger the foam, the better the subsurface storage capability as a relatively strong form generates a relatively high pressure gradient in the porous media.

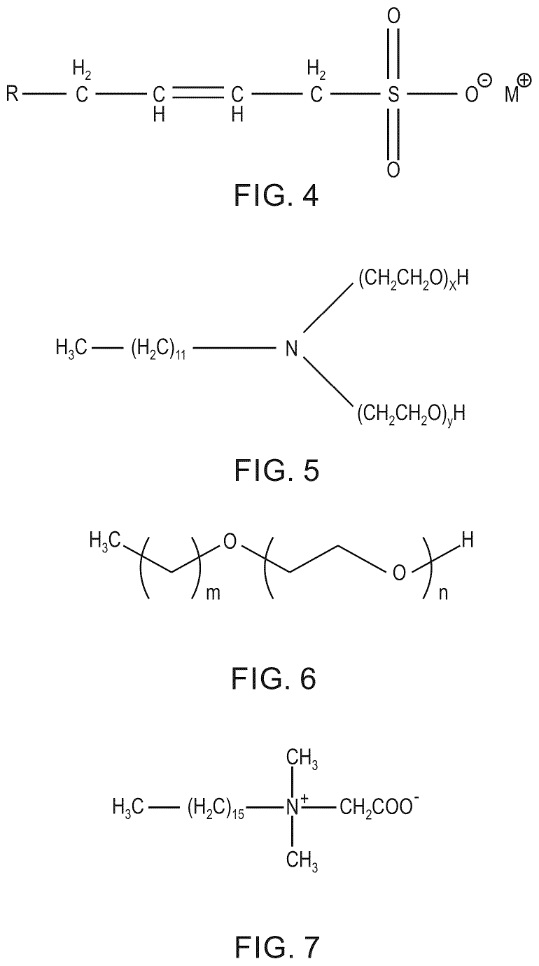

Examples of anionic surfactants include sodium lauryl sulfate (SLS), sodium laureth sulfate (SLES), sodium cocoyl isethionate (SCI), sodium lauryl sulfoacetate (SLSA), alpha olefin sulfonates (AOS), sodium dodecylbenzene sulfonate (SDBS), sodium alkyl ether sulfate (AES), sodium lauryl ether sulfate (SLES), sodium lauroyl sarcosinate (SLS), and sodium lauroyl glutamate. A structure of an alpha-olefin sulfonate is shown in FIG. 4. In this structure, R can be a C₁₀₋₂₀ hydrocarbon (e.g., alkyl, alkenyl) chain. Examples of M⁺ include Na⁺, K⁺, and NH₄⁺.

Examples of cationic surfactants include cetyltrimethylammonium bromide (CTAB), cetrimonium chloride, stearalkonium chloride, behentrimonium chloride, protonated primary, secondary and tertiary amines and fatty amine derivatives and ethoxylated amines. A structure of an ethoxylated amine is shown in FIG. 5. In this structure, examples of x and y are x=1 and y=1. Without wishing to be bound by theory, it is believed that ethoxylated amines can generate a strong foam when it is protonated.

Examples of nonionic surfactants include alkyl ethoxylated, alkylphenol ethoxylated, alkyl ethylene oxide (EO) and propylene oxide (PO) block copolymers or random copolymers. A structure of an alkyl ethoxylated copolymer is shown in FIG. 6. In this structure, examples of m and n are m=12 and n=22.

Examples of zwitterionic surfactants include cocamidopropyl betaine, cetyl betaine, lauryl betaine, oleamidopropyl betaine, capryl/capramidopropyl betaine, decyl glucoside betaine, stearyl betaine, behenyl betaine, and cetrimonium betaine. A structure of cetyl betaine is shown in FIG. 7. Without wishing to be bound by theory, it is believed that zwitterionic surfactants can be used as the surfactant or surfactant booster for generating stable foams. For example, lauryl betaine (LB) can be used as a booster for AOS foams (see discussion above).

In some embodiments, the surfactant includes C₁₄₋₁₆ AOS, C₁₂₋₁₄(—CH₂—CH₂—O—)₂₂, cocamidopropyl betaine, cetyl betaine, and/or lauryl betaine. For C₁₂₋₁₄(—CH₂—CH₂—O—)₂₂, 22 is the average number of the —CH₂—CH₂—O— groups and more or less may be present, such as 10-40.

In general, the foam has a neutral pH (e.g., a pH of from 6.5 to 7.5). Without wishing to be bound by theory, it is believed that at a relatively low pH (e.g., a pH of less than 6) the acidic fluid can react with carbonate formations and at a relatively high pH (e.g., a pH of at least 8.5) the basic fluid can cause precipitation of calcium and magnesium ions.

Generally, the foam can have any appropriate viscosity.

In general, various factors can be taken into consideration when selecting an appropriate surfactant. For example, in some embodiments, the surfactant can be selected based on the aqueous phase (e.g., concentration of certain ions), the target reservoir type (e.g., sandstone, carbonate), and the temperature. Without wishing to be bound by theory, it is believed that when significant amounts of Ca²⁺ and/or Mg²⁺ ions are present in the brine, the anionic surfactant may precipitate, thus a nonionic surfactant may be preferred. Without wishing to be bound by theory, it is believed that nonionic surfactants are not preferred for relatively high temperature reservoirs (e.g., greater than 100° C.) as the surfactant may experience cloud point issues and phase out.

Without wishing to be bound by theory, it is believed that in sandstone reservoirs, the sandstone surface has a net negative charge. Typically, this means that anionic surfactants can yield relatively good results as the electrostatic repulsion between the surfactant and the rock surface can reduce surfactant adsorption. In general, nonionic surfactants may form hydrogen bonds with the sandstone surface, resulting in relatively high adsorption of the nonionic surfactant to the sandstone. Cationic surfactants are also generally not recommended in such situations as cationic surfactants may have relatively high absorption on the negatively charged rock surfaces. Absorption of the surfactant can result in surfactant loss on the rocks surfaces resulting in an absence of surfactant for generating foams, thus being detrimental to subsurface hydrogen storage.

Without wishing to be bound by theory it is believed that in carbonate reservoirs, the carbonate surface has a net positive charge. Typically, this means that cationic and nonionic surfactants yield good results as due to their relatively low absorption to the carbonate. Anionic surfactants are not recommended in such situations as anionic surfactants may have relatively high absorption on the positively charged rock surfaces.

Without wishing to be bound by theory, it is believed that zwitterionic surfactants can be applied in either sandstone or carbonate reservoirs. However, in general, it is desirable to verify the suitability of a given surfactant to ensure relatively low absorption of the surfactant to surfaces of the underground formation. In general, the absorption of the surfactant to the surface of the reservoir should be less than 1 mg/g of rock.

Table 1 lists non-limiting examples of some surfactant and foam generation methods for certain aqueous phases and target reservoir types.

TABLE 1

| | | Target reservoir | Foam generation |
|---|---|---|---|
| Surfactant | Aqueous phase | type | method |
| Alkyl ethoxylated nonionic | River water, | Carbonate | Surface generation or |
| surfactant: Cₘ(EO)ₙ, with | formation brine, | | subsurface in situ |
| EO = —CH₂—CH₂—O—, | sea water | | generation |
| m = 8-20, and n = 8-30 (FIG. 6) | | | |
| Alpha-olefin sulfonate or | River water, | Sandstone | Surface generation or |
| ethoxylated alpha-olefin | formation brine, | | subsurface in situ |
| sulfonate with hydrophobic | sea water | | generation |
| chain length of C₁₀-C₂₀ | | | |
| (FIG. 4) | | | |
| Lauryl betaine | River water, | Carbonate or | Surface generation or |
| | formation brine, | sandstone | subsurface in situ |
| | sea water | | generation |

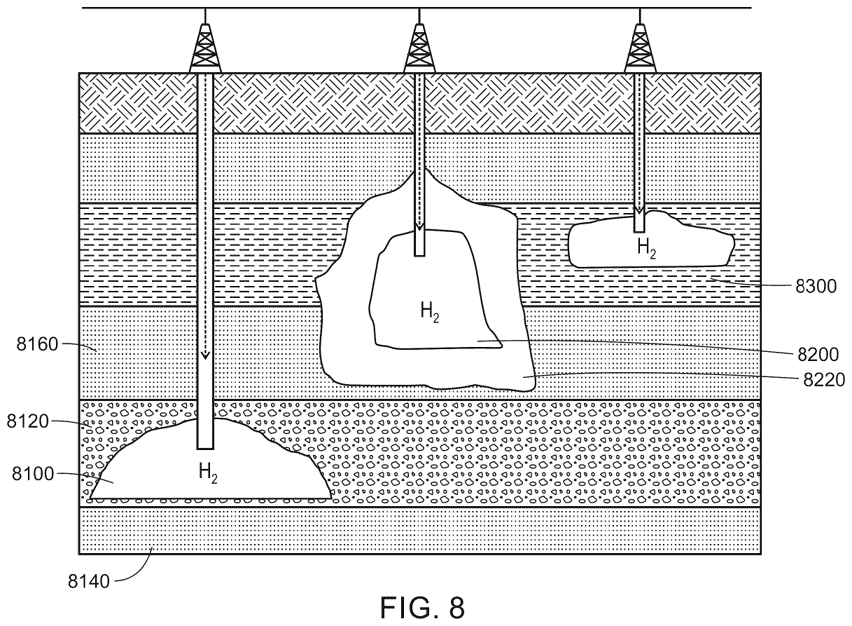

FIG. 8 depicts a schematic of a depleted reservoir 8100 in a porous reservoir rock 8210 and above an impermeable seal 8140, a cavern 8200 in a salt deposit 8220, and an aquifer 8300 in their geological contexts. An impermeable cap rock 8160 with relatively low permeability may be above the porous reservoir rock 8210. The aquifer 8300 corresponds to water trapped in a porous media (e.g., soil with sand, soil with clay). Without wishing to be bound by theory, it is believed that hydrogen can be stored in caverns 8200 (e.g., caverns formed by salt deposits 8220), aquifers 8300 (e.g., a saline aquifer) and/or depleted oil/gas reservoirs 8100. When stored in a depleted oil and gas reservoir 8100, the existing injection and production facilities can be used. Additionally, such reservoirs are believed to have relatively good integrity, relatively high pore volumes for hydrogen storage, and relatively wide availability in sedimentary basins globally.

Without wishing to be bound by theory, it is believed that the aquifer 8300 has relatively high permeability which is typically good for foam generation. As the water saturation is relatively high, there may be some surfactant front dispersion, but once the gas/foam occupies the pore space front, it will reduce (e.g., prevent) the following foam (liquid and gas) to “diffuse away” since both relative permeability of hydrogen and the surfactant solution are significantly reduced in the flow front.

In general, the stored hydrogen can be produced as appropriate. Without wishing to be bound by theory, it is believed that when producing the hydrogen and using water as a displacing agent, the surfactant carried by the invading water can mix with hydrogen to displace the hydrogen gas front more effectively, leading to greater hydrogen production.

Generally, the porosity of the rock depends on the reservoir. In certain embodiments, the porosity of the rock is at least 1 (e.g., at least 2, at least 5, at least 10, at least 15, at least 20, at least 25, at least 30, at least 35, at least 40, at least 45) % and/or at most 50 (e.g., at most 45, at most 40, at most 35, at most 30, at most 25, at most 20, at most 15, at most 10, at most 5, at most 2) %.

### Examples

A high-pressure blender that features a visual cell was used to mix pressurized hydrogen and a surfactant solution. This configuration permitted the surfactant solution and pressurized hydrogen gas to be mixed, creating a foam column that can be measured using the visual cell window. By employing this arrangement, suitable surfactants for producing hydrogen foam while operating under pressurized conditions can be determined.

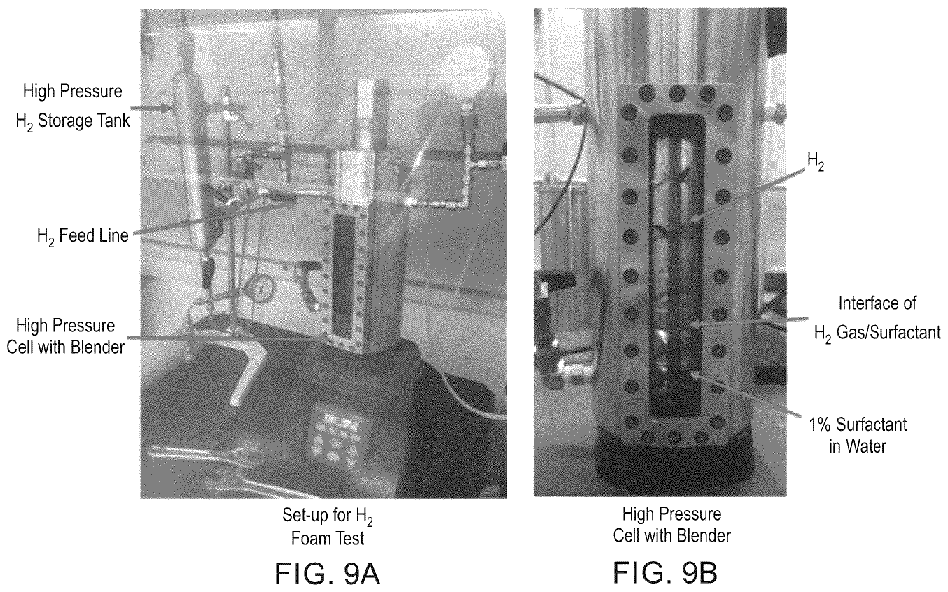

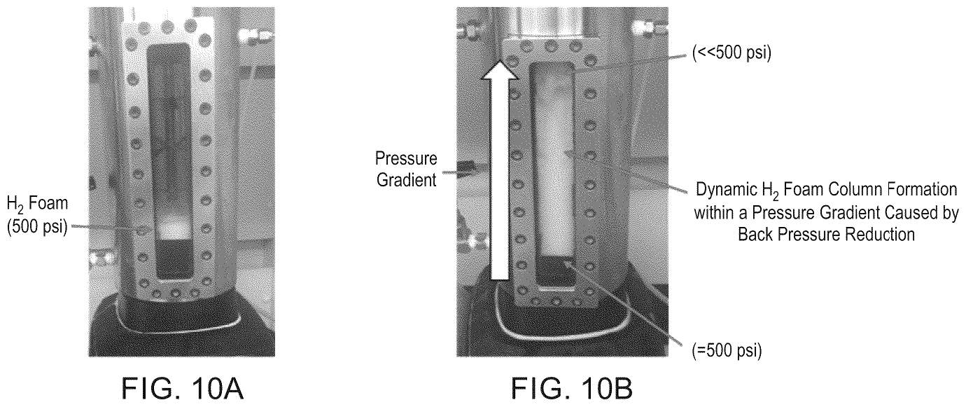

FIGS. 9A-9B and 10A-10B depict the production of foam. The process involved introducing 350 mL of 1 wt. % C₁₂₋₁₄(—CH₂—CH₂—O—)₂₂ in water at room temperature and 500 psi into the high-pressure foam generator, where the blender generated foam within the high-pressure cell at shear rates of 1000 rpm. The cell had a volume capacity of approximately 1100 mL, leaving 750 mL for high-pressure hydrogen gas (500 psi) at the top of the cell. A dense foam was created by blending at 1000 rpm for about 30-40 seconds. Upon depressurization of the system, the internal expansion of hydrogen produced a dense hydrogen foam due to the large pressure gradient within the cell.

FIG. 9A shows the solution containing the surfactant and high-pressure hydrogen before being mixed. FIG. 9B shows the cell containing the surfactant and hydrogen before mixing. The cell was initially pressurized with 500 psi hydrogen, followed by depressurization of the high-pressure hydrogen and flow of pure hydrogen from the upstream inlet. This cycle was repeated five times to ensure that the cell was filled with hydrogen.

FIGS. 10A and 10B show the foam formation and foam column expansion. In FIG. 10A, no pressure gradient is present, whereas in FIG. 10B a sudden pressure gradient is present from releasing the back pressure.

### Embodiments

1. A method including:
   injecting a foam including hydrogen and a surfactant into an underground formation.
2. The method of embodiment 1, further including, prior to injecting the foam, mixing the hydrogen and the surfactant to form the foam.
3. The method of embodiment 2, further including, before mixing the hydrogen and the surfactant, disposing the surfactant in a liquid, wherein a concentration of the surfactant used to form the foam is from 0.1 wt. % to 2 wt. % in the liquid.
4. The method of any one of embodiments 1-3, wherein a volume ratio of hydrogen to surfactant in the foam is from 1:1 to 20:1.
5. The method of any one of embodiments 1-4, wherein a volume fraction of hydrogen is from 50 vol. % to 95 vol. % of the foam.
6. The method of any one of embodiments 1-5, wherein the underground formation includes a member selected from the group consisting of an aquifer, a cavern, and a depleted oil or gas reservoir.
7. The method of any one of embodiments 1-6, further including, after injecting the foam into the underground formation, producing hydrogen from the underground formation.
8. The method of any one of embodiments 1-7, wherein the surfactant includes a member selected from the group consisting of an anionic surfactant, a cationic surfactant, a nonionic surfactant and a zwitterionic surfactant.
9. The method of any one of embodiments 1-8, wherein the surfactant includes a surfactant selected from the group consisting of:
   an anionic surfactant selected from the group consisting of sodium lauryl sulfate (SLS), sodium laureth sulfate (SLES), sodium cocoyl isethionate (SCI), sodium lauryl sulfoacetate (SLSA), alpha olefin sulfonates (AOS), sodium dodecylbenzene sulfonate (SDBS), sodium alkyl ether sulfate (AES), sodium lauryl ether sulfate (SLES), sodium lauroyl sarcosinate (SLS), and sodium lauroyl glutamate;
   a cationic surfactant selected from the group consisting of cetyltrimethylammonium bromide (CTAB), cetrimonium chloride, stearalkonium chloride, behentrimonium chloride, protonated primary, secondary and tertiary amines and fatty amine derivatives and ethoxylated amines;
   a nonionic surfactant selected from the group consisting of alkyl ethoxylated, alkylphenol ethoxylated, alkyl ethylene oxide (EO) and propylene oxide (PO) block copolymers; and
   a zwitterionic surfactant selected from the group consisting of cocamidopropyl betaine, cetyl betaine, lauryl betaine, oleamidopropyl betaine, capryl/capramidopropyl betaine, decyl glucoside betaine, stearyl betaine, behenyl betaine, and cetrimonium betaine.
10. A method including:
   forming, within an underground formation, a foam including hydrogen and a surfactant.
11. The method of embodiment 10, further including, prior to forming the foam, injecting the hydrogen and the surfactant into the underground formation.
12. The method of embodiment 11, wherein:
   the hydrogen and the surfactant are coinjected; or
   the hydrogen is injected at a first time and the surfactant is injected at a second time different from the first time.
13. The method of embodiment 11 or 12, further including, before injecting the surfactant, disposing the surfactant in a liquid, wherein a concentration of the surfactant used to form the foam is from 0.1 wt. % to 2 wt. % in the liquid.
14. The method of any one of embodiments 10-13, wherein a volume ratio of hydrogen to surfactant solution in the foam is from 1:1 to 20:1.
15. The method of any one of embodiments 10-14, wherein a volume fraction of hydrogen is from 50 vol. % to 95 vol. % of total fluid injected.
16. The method of any one of embodiments 10-15, wherein the underground formation includes a member selected from the group consisting of an aquifer, a cavern, and a depleted oil or gas reservoir.
17. The method of any one of embodiments 10-16, further including, after forming the foam in the underground formation, producing hydrogen from the underground formation.
18. The method of any one of embodiments 10-17, wherein the surfactant includes a member selected from the group consisting of an anionic surfactant, a cationic surfactant, a nonionic surfactant and a zwitterionic surfactant.
19. The method of any one of embodiments 10-18, wherein the surfactant includes a surfactant selected from the group consisting of:
   an anionic surfactant selected from the group consisting of sodium lauryl sulfate (SLS), sodium laureth sulfate (SLES), sodium cocoyl isethionate (SCI), sodium lauryl sulfoacetate (SLSA), alpha olefin sulfonates (AOS), sodium dodecylbenzene sulfonate (SDBS), sodium alkyl ether sulfate (AES), sodium lauryl ether sulfate (SLES), sodium lauroyl sarcosinate (SLS), and sodium lauroyl glutamate;
   a cationic surfactant selected from the group consisting of cetyltrimethylammonium bromide (CTAB), cetrimonium chloride, stearalkonium chloride, behentrimonium chloride, protonated primary, secondary and tertiary amines and fatty amine derivatives and ethoxylated amines;
   a nonionic surfactant selected from the group consisting of alkyl ethoxylated, alkylphenol ethoxylated, alkyl ethylene oxide (EO) and propylene oxide (PO) block copolymers; and
   a zwitterionic surfactant selected from the group consisting of cocamidopropyl betaine, cetyl betaine, lauryl betaine, oleamidopropyl betaine, capryl/capramidopropyl betaine, decyl glucoside betaine, stearyl betaine, behenyl betaine, and cetrimonium betaine.
20. A system including:
   an underground formation including a member selected from the group consisting of an aquifer, a cavern, and a depleted oil or gas reservoir; and
   a foam disposed in the underground formation,
   wherein the foam includes hydrogen and a surfactant.

What is claimed:

1. A method comprising:
injecting a foam comprising hydrogen and a surfactant into an underground formation.

2. The method of claim 1, further comprising, prior to injecting the foam, mixing the hydrogen and the surfactant to form the foam.

3. The method of claim 2, further comprising, before mixing the hydrogen and the surfactant, disposing the surfactant in a liquid, wherein a concentration of the surfactant used to form the foam is from 0.1 wt. % to 2 wt. % in the liquid.

4. The method of claim 1, wherein a volume ratio of hydrogen to surfactant in the foam is from 1:1 to 20:1.

5. The method of claim 1, wherein a volume fraction of hydrogen is from 50 vol. % to 95 vol. % of the foam.

6. The method of claim 1, wherein the underground formation comprises a member selected from the group consisting of an aquifer, a cavern, and a depleted oil or gas reservoir.

7. The method of claim 1, further comprising, after injecting the foam into the underground formation, producing hydrogen from the underground formation.

8. The method of claim 1, wherein the surfactant comprises a member selected from the group consisting of an anionic surfactant, a cationic surfactant, a nonionic surfactant and a zwitterionic surfactant.

9. The method of claim 1, wherein the surfactant comprises a surfactant selected from the group consisting of:
an anionic surfactant selected from the group consisting of sodium lauryl sulfate (SLS), sodium laureth sulfate (SLES), sodium cocoyl isethionate (SCI), sodium lauryl sulfoacetate (SLSA), alpha olefin sulfonates (AOS), sodium dodecylbenzene sulfonate (SDBS), sodium alkyl ether sulfate (AES), sodium lauryl ether sulfate (SLES), sodium lauroyl sarcosinate (SLS), and sodium lauroyl glutamate;
a cationic surfactant selected from the group consisting of cetyltrimethylammonium bromide (CTAB), cetrimonium chloride, stearalkonium chloride, behentrimonium chloride, protonated primary, secondary and tertiary amines and fatty amine derivatives and ethoxylated amines;
a nonionic surfactant selected from the group consisting of alkyl ethoxylated, alkylphenol ethoxylated, alkyl ethylene oxide (EO) and propylene oxide (PO) block copolymers; and
a zwitterionic surfactant selected from the group consisting of cocamidopropyl betaine, cetyl betaine, lauryl betaine, oleamidopropyl betaine, capryl/capramidopropyl betaine, decyl glucoside betaine, stearyl betaine, behenyl betaine, and cetrimonium betaine.

10. A method comprising:
forming, within an underground formation, a foam comprising hydrogen and a surfactant.

11. The method of claim 10, further comprising, prior to forming the foam, injecting the hydrogen and the surfactant into the underground formation.

12. The method of claim 11, wherein:
the hydrogen and the surfactant are coinjected; or
the hydrogen is injected at a first time and the surfactant is injected at a second time different from the first time.

13. The method of claim 11, further comprising, before injecting the surfactant, disposing the surfactant in a liquid, wherein a concentration of the surfactant used to form the foam is from 0.1 wt. % to 2 wt. % in the liquid.

14. The method of claim 10, wherein a volume ratio of hydrogen to surfactant solution in the foam is from 1:1 to 20:1.

15. The method of claim 10, wherein a volume fraction of hydrogen is from 50 vol. % to 95 vol. % of total fluid injected.

16. The method of claim 10, wherein the underground formation comprises a member selected from the group consisting of an aquifer, a cavern, and a depleted oil or gas reservoir.

17. The method of claim 10, further comprising, after forming the foam in the underground formation, producing hydrogen from the underground formation.

18. The method of claim 10, wherein the surfactant comprises a member selected from the group consisting of an anionic surfactant, a cationic surfactant, a nonionic surfactant and a zwitterionic surfactant.

19. The method of claim 10, wherein the surfactant comprises a surfactant selected from the group consisting of:
an anionic surfactant selected from the group consisting of sodium lauryl sulfate (SLS), sodium laureth sulfate (SLES), sodium cocoyl isethionate (SCI), sodium lauryl sulfoacetate (SLSA), alpha olefin sulfonates (AOS), sodium dodecylbenzene sulfonate (SDBS), sodium alkyl ether sulfate (AES), sodium lauryl ether sulfate (SLES), sodium lauroyl sarcosinate (SLS), and sodium lauroyl glutamate;
a cationic surfactant selected from the group consisting of cetyltrimethylammonium bromide (CTAB), cetrimonium chloride, stearalkonium chloride, behentrimonium chloride, protonated primary, secondary and tertiary amines and fatty amine derivatives and ethoxylated amines;
a nonionic surfactant selected from the group consisting of alkyl ethoxylated, alkylphenol ethoxylated, alkyl ethylene oxide (EO) and propylene oxide (PO) block copolymers; and
a zwitterionic surfactant selected from the group consisting of cocamidopropyl betaine, cetyl betaine, lauryl betaine, oleamidopropyl betaine, capryl/capramidopropyl betaine, decyl glucoside betaine, stearyl betaine, behenyl betaine, and cetrimonium betaine.

20. A system comprising:
an underground formation comprising a member selected from the group consisting of an aquifer, a cavern, and a depleted oil or gas reservoir; and
a foam disposed in the underground formation,
wherein the foam comprises hydrogen and a surfactant.
